(19) United States
(12) Patent Application Publication
(10) Pub. No.: US 2026/0233040 A1
(43) Pub. Date: Aug. 13, 2026

(54) FOAM EXTINGUISHING SYSTEM, PROCEDURES FOR COMMISSIONING AND ENSURING FUNCTIONALITY

(71) Applicant: Minimax Viking Patent Management GmbH, Bad Oldesloe (DE)

(72) Inventors: Thorsten GIESEKE, Bad Oldesloe (DE); Marcus HOCHSCHILD, Bad Oldesloe (DE); Jan STARK, Bad Oldesloe (DE)

(21) Appl. No.: 18/967,207

(22) Filed: Dec. 3, 2024

(30) Foreign Application Priority Data
Dec. 6, 2023 (EP) 23214786.8

(51) Int. Cl. A62C 35/60; A62C 35/64; A62C 35/68; A62C 37/50

(52) U.S. Cl. CPC A62C 35/60; A62C 35/64; A62C 35/68; A62C 37/50

(57) ABSTRACT

A foam extinguishing system with a fluid supply for providing a pressurized initial fluid, a pipe system in fluid-conducting connection with the fluid supply, the pipe system including a proportioning device with a foam proportioner and a foam agent reservoir for producing a foam agent fluid mixture by proportioning a foam agent from the foam agent reservoir the into the initial fluid for filling the pipe system with foam agent fluid mixture, and at least one extinguishing foam outlet for discharging the foam agent fluid mixture in a protected area. The foam extinguishing system further includes a filling device in fluid-conducting connection with the pipe system. The filling device including a filling valve and a filling supply for supplying a filling foam agent fluid mixture. A method for ensuring the functionality of the foam extinguishing system and for commissioning the foam extinguishing system is provided.

### PRIORITY CLAIM AND INCORPORATION BY REFERENCE

This application claims the benefit of European Application No. 23214786.8, filed Dec. 6, 2023, which is incorporated by reference in its entirety.

### TECHNICAL FIELD

The invention relates to a foam extinguishing system for fire-fighting, a method for commissioning the same and a method for ensuring the functionality of the same.

### BACKGROUND OF THE INVENTION

Foam extinguishing systems are commonly used to extinguish fires in rooms or in, or on, objects such as machines, gas turbines, warehouses and others. This is done by connecting a foam agent supply via pipes to foam outlets, usually sprinklers or nozzles, and discharging the extinguishing foam through these outlets in response to a fire parameter.

In known foam extinguishing systems, the foam agent supply provides the foam agent water mixture, a mixture of, usually, water as the initial fluid and a concentrated foam agent, which is usually present in the pipe network without foaming. The foaming of the foam agent water mixture to form an extinguishing foam usually takes place when the mixture emerges from the outlets. In some cases, however, pre-expansion or even full expansion can already take place within the pipe network, for example by introducing air or other gases into the foam agent water mixture, often by means of so-called Venturi nozzles or Venturi pipes. In principle, other additives can also be added to the initial fluid in addition to the foam agent, for example antifreeze for use at particularly low temperatures. Additives can be mixed in before or after the foam agent is added.

Like conventional water-based sprinkler systems, foam extinguishing systems are often so-called wet alarm systems, in which the pipe network is filled with foam agent water mixture up to the outlets when not in use. The outlets in wet alarm systems are usually pressurized with the foam agent water mixture and closed by closing elements when not in use, whereby the foam extinguishing system is activated from the idle state to the extinguishing state depending on the fire parameters. The outlets are opened by releasing the closing elements, for example in the form of passive heat-sensitive closing elements such as glass ampoules, active signal-controlled closing elements in conjunction with fire detectors or fire alarm control panels, or combined closing elements that are both heat-sensitive and signal-controlled.

When such foam extinguishing systems are activated, a fluid pump is usually also activated, which then pumps water in the pipe network towards the foam outlets. The fluid pump is activated either by a control signal from fire detectors or fire alarm control panels, or by a pressure sensor, so-called pump start pressure switch, which registers the drop in fluid pressure in the pipe network, which in turn is caused by the fluid discharge at the foam outlets.

Known foam extinguishing systems of this type usually also have alarm valves that are opened under pressure control. These are configured in such a way that in the idle state, i.e. when the foam outlets are closed, the valve cover of the alarm valve is kept closed by the fluid pressure in the downstream part of the pipe network. If one or more foam outlets are now opened, the pressure in the downstream part of the pipe network drops so that the valve cover opens and the fluid connection between the fluid pump and foam outlets is established, the fluid pump is started and an alarm is triggered. As a rule, such alarm valves have a so-called bypass between the valve inlet and outlet, which allows small quantities of fluid to pass unhindered from the valve side facing the pump to the valve side facing the outlets. This allows small fluctuations in fluid pressure to be compensated for without the alarm valve opening and triggering a false alarm.

The foam agent supply is usually located downstream of the fluid pump, usually upstream of an alarm valve. The foam agent supply contains a foam proportioner which is connected to the pipe network and evenly adds foam agent to the water to produce the foam agent water mixture at a predetermined proportioning rate, i.e. the mixing ratio of foam agent and water. Various types of foam agent supply systems are known in the prior art, for example with membrane tanks, in which the foam agent is constantly pressurized in a tank made of flexible material, or with static tanks, in which either a propellant such as inert gas pressurizes the foam agent or a pump delivers the foam agent.

Known foam agent supplies have foam proportioners which, for example, passively release foam agent into the pipe network depending on the fluid pressure or flow velocity of the water, or actively measure fluid pressure or flow velocity in the pipe network and then control the release rate of the foam agent into the water. In both variants, a predetermined proportioning rate should be achieved as accurately as possible, whereby the required proportioning rates depend on the respective foam agent and, in some cases, foam extinguishing system-specific requirements. The manufacturer of the foam agent usually specifies a proportioning rate to be achieved, and the legal requirements or the test guidelines of certification bodies require compliance with tolerance limits up to which the actual proportioning rate may deviate at most.

Finally, foam agent water mixtures with too high or too low proportioning rate can lead to extinguishing foam with an inadequate extinguishing effect. For example, the resulting extinguishing foam may have a too high or too low foaming index, i.e. the volume ratio between the finished extinguishing foam and the original foam agent water mixture. This results in the extinguishing foam obtaining significantly more volume and becoming drier than desired, or in the volume no longer being sufficient to cover the area to be protected. Other physical properties of the extinguishing foam also depend directly on the foaming index, whereby extinguishing foams with a low foaming index are wetter and cool better, can be thrown further, but also adhere less well to surfaces and flow better. Extinguishing foams with a high foaming index, on the other hand, are drier, adhere and stand better, i.e. they can be piled high without flowing away, but they hardly cool at all. Furthermore, an incorrect proportioning rate can cause the resulting extinguishing foam to decompose much faster, whether under the influence of heat or not.

In particular, many of the newly developed fluorine-free foam agents change their respective extinguishing effect and physical properties particularly strongly depending on the proportioning rate, which makes compliance with the specified, tested and approved proportioning rates of these foam agents particularly important.

Known foam proportioners generally require a certain minimum flow velocity or rate of the water through the proportioning area, i.e. the area of the pipe network in which the foam agent is added to the water, in order to deliver foam agent at all or to add foam agent in the desired quantity, i.e. for the desired proportioning rate.

This minimum flow velocity or rate is often negligible when the foam extinguishing system is activated, as when one or more foam outlets are opened, enough foam agent water mixture escapes and new initial fluid can be delivered by the fluid pump to achieve this minimum flow velocity or rate after a short time. This ensures that the newly generated foam agent water mixture largely has the desired proportioning rate and that the extinguishing foam formed from it largely has the desired physical properties and extinguishing effects.

In addition to the foam outlets, known foam extinguishing systems of this type usually have one or more test valves in the pipe network, which can be used to temporarily open the pipe network, whereby the opening can be controlled manually, electrically or hydraulically.

Foam extinguishing systems often have to be put into operation for the first time after installation, or again after partial or complete emptying, among other things by filling the pipe network up to the nozzles with foam agent water mixture. To do this, any existing shut-off or alarm valves are opened or unlocked and the fluid pump and foam proportioner are activated, flooding the pipe network with the foam agent water mixture produced.

One or more of the test valves, or other outlet valves, can be opened during or before the pipe network is filled so that air or other fluids still in the pipe network, such as antifreeze or water, can escape via the open valves.

Furthermore, it is often necessary to take samples of the foam agent water mixture in foam extinguishing systems that are already in operation, for example for further tests such as checking the correct proportioning rate. Samples are taken through the test valves in the pipe network, usually a few liters of the foam agent water mixture are taken. The tests can then be carried out on site or at a suitable location.

For example, the European insurer guideline CEA 4001 (in the version VdS CEA 4001:2021-01 (07), paragraph M.1.2) requires that the foam agent water mixture in the pipe network must be subjected to a quality test depending on the manufacturer's specifications, but at least once a year, for which a sample must be taken at three different points, namely at the proportioning point, in the middle of the ceiling pipe network or at points subject to thermal stress and at the end of the pipe network at the extraction connections provided for this purpose.

Sampling directly reduces the amount of foam agent water mixture in the pipe network, which reduces the hydrostatic pressure in the pipe network. If the pressure in the pipe network is too low, the valve cover of the alarm valves may open, causing a false alarm. However, low extraction volumes can also be compensated for by the bypass on the alarm valve, whereby the foam agent water mixture already produced flows through the bypass towards the foam outlets.

In most cases, sampling alone does not activate the fluid pump due to the fluid pressure falling below a pump start pressure threshold, as other regular maintenance work leads to a scheduled pump start, after which the pipe network is then sufficiently refilled with foam agent water mixture. For example, regular valve tests are often required, whereby a test valve is opened above an alarm valve for an extended period of time to force the valve cover to open and the resulting alarm to sound. Regular system emptying and filling may also be required. These other regular maintenance tasks are therefore usually carried out before the pressure drop from the sampling itself would lead to pump activation.

In its own, as yet unpublished and manufacturer-independent investigation of installed foam extinguishing systems, the applicant has found that in some cases the specified proportioning rate of the foam compound to the initial fluid is not complied with despite proper operation and maintenance.

The reason for this was identified as the real proportioning rate at the foam agent proportioner deviating too much from the specification at very low flow rates, which is caused by the very low volume of fluid to be delivered by the fluid pump. In other words, the fluid pump is often unable to deliver such a small volume at the flow rate required by the foam proportioner in order to precisely achieve the set proportioning rate.

In addition, the applicant has recognized that taking samples of only a few liters at a time does not adequately reflect the proportioning rate in the foam agent water mixture in the pipe network. It may therefore be advisable to take samples with a larger sample volume. However, this would increase the frequency of pump activations due to the pressure drop caused by sampling, which would even exacerbate the problem identified by the applicant.

The consequence of all this is that parts of the foam agent water mixture may be present in the pipe network which do not have a sufficient extinguishing effect.

An obvious solution to this problem is to use the foam proportioner together with the fluid pump to generate the foam agent water mixture and to discharge the foam agent water mixture in the pipe network or initially introduced at a remote point until a homogeneous proportioning rate is achieved and maintained across the entire pipe network. However, the discharged mixture must be collected and disposed of at great expense in order to prevent contamination of waste water or groundwater.

It is therefore the task of the present invention to provide a method for commissioning a foam extinguishing system and a method for ensuring the functionality of a foam extinguishing system, in which the entire foam extinguishing system is not commissioned and large quantities of foam-containing liquids to be disposed of are discharged.

### SUMMARY OF THE INVENTION

The invention solves the underlying problem by proposing a method for ensuring the functionality of a foam extinguishing system, a method for commissioning a foam extinguishing system, and a foam extinguishing system suitable therefor.

The foam extinguishing system according to the invention comprises a fluid supply for providing a pressurized initial fluid, a pipe system in fluid-conducting connection with the fluid supply, wherein the pipe system comprises a proportioning device with a foam proportioner and a foam agent reservoir for producing a foam agent fluid mixture by proportioning a foam agent from the foam agent reservoir to the initial fluid for filling the pipe system with foam agent fluid mixture, at least one extinguishing foam outlet for discharging the foam agent fluid mixture in a protected area, characterized in that the foam extinguishing system further comprises a filling device in fluid-conducting connection with the pipe system, the filling device comprising a filling valve and a filling supply for supplying a filing foam agent fluid mixture.

In a preferred embodiment, the fluid supply comprises a fluid pump for conveying the initial fluid in the pipe system. The fluid pump can generate sufficient pressurization, allowing the use of unpressurized fluid reservoirs such as sprinkler ponds or water tanks or fluid connections with insufficient pressurization if required. This includes foam extinguishing systems where, for example, very high discharge pressures must be achieved in order to convey the fluid over several floors of a building.

Such a fluid pump is usually not permanently active but is activated as required via a fluid pump start control. This start control usually comprises a fluid pump control cabinet and a fluid pump start switch, whereby the start switch is usually in the form of a so-called pump start pressure switch in fluid-conducting connection with the pipe system, whereby such a pump start pressure switch reacts to the drop in fluid pressure in a part of the pipe system and starts the fluid pump when the pressure drops below a threshold value.

Alternatively, the fluid supply for providing a pressurized initial fluid can be, for example, a municipal water supply or a connection to such a municipal water supply. Such municipal water supplies often already provide sufficient pressurized water, so that an additional fluid pump can often be dispensed with.

The initial fluid is preferably water, although various additives can be mixed with it. For example, it is possible to add antifreeze or corrosion inhibitors to the initial fluid. What is relevant is that the initial fluid together with the foam agent used, i.e. the foam agent fluid mixture, achieves the desired extinguishing effect.

A pipe system is understood to be a pipe arrangement that is configured to guide the initial fluid and fluids based on it from the fluid supply to the extinguishing agent outlet(s). The pipe arrangement can comprise rigid pipes, such as metal or plastic pipes, or flexible pipes, such as hoses. The pipe system can be a multi-branched system with a total pipe length of several hundred meters, or a direct-connecting system with a length of less than one or a few meters, or anything in between. The pipe system can be installed anywhere, for example on ceilings, near the floor or underground, or in any combination. The pipe system includes further components or devices, which are in particular fluid-carrying or fluid-contacting.

The proportioning device mixes a foam agent into the initial fluid and produces a foam agent fluid mixture. For this purpose, the proportioning device has a foam proportioner, which mixes a foam agent into a supplied initial fluid, and a foam agent reservoir. The foam agent reservoir can be detachably connected to the foam proportioner, for example in the form of a foam agent container with a hose or pipe connection, or non-detachably connected to the foam proportioner, for example integrated together in a proportioning device. Foam proportioners preferably add the foam agent directly into the flowing initial fluid in order to produce a foam agent fluid mixture with a desired proportioning rate.

The proportioning device as part of the pipe system is preferably connected downstream of the fluid supply, i.e. the initial fluid from the fluid supply is fed through the pipe system to the proportioning device. Alternatively, it is also possible that the proportioning device is connected upstream of some parts of the fluid supply, for example in particular the fluid pump, whereby a foam agent fluid mixture is generated and then conveyed into the pipe system by the fluid pump, for example. This is possible, non-exclusively, in particular if the fluid supply already provides pressurized initial fluid, even if not necessarily sufficient, so that the initial fluid can flow before the conveying pressure is increased by a fluid pump.

In a preferred embodiment, the pipe system comprises an alarm valve and a bypass around the alarm valve. The alarm valve prevents the fluid-conducting connection between the fluid supply and the extinguishing foam outlets in the idle state for larger fluid quantities, whereby the bypass continues to enable the fluid connection for small fluid quantities in order to enable pressure equalization on both sides of the alarm valve even in the idle state. The alarm valve can preferably perform a shut-off function, whereby the alarm valve temporarily does not open properly if, for example, there is a critical fluid pressure difference, but remains closed.

The extinguishing foam outlets are configured to discharge the foam agent fluid mixture into an area. The area can be closed or open rooms, closed or open machine systems or liquid tanks, or any other object. The extinguishing foam outlets are preferably designed in such a way that they themselves contribute to foaming, i.e. to the mixing of air or gas into the foam agent fluid mixture while increasing the volume, and thus to the generation of extinguishing foam. Alternatively or additionally, other foaming devices can also be arranged in the pipe system in order to carry out pre- or full foaming even before discharge through the extinguishing foam outlets. However, the term “extinguishing foam outlets” is not to be understood restrictively to mean that the generation of extinguishing foam is absolutely necessary. It is not essential that the foam agent fluid mixture achieves sufficient foaming. Even a non-foaming mixture, so-called wetting water, has advantageous properties with regard to its extinguishing effect.

The extinguishing foam outlets are preferably foam sprinklers, i.e. foam nozzles with a closing element, such as glass ampoules or fusible links, which keep the extinguishing foam outlets closed when not in use and release them to discharge extinguishing foam into the environment depending on the ambient heat. Alternatively, active closing elements are also proposed, which release the outlets in response to a signal, usually electrical, from a fire detector or a fire alarm system. Such active closing elements can also be located upstream of the actual foam nozzles, i.e. at a distance from the nozzles in the pipe system, whereby the closing elements are then usually in the form of controllable valves.

Alternatively, the extinguishing foam outlets are individual outlets or groups of outlets located close together, such as in extinguishing monitors, extinguishing turbines or larger foam generators.

The foam extinguishing system according to the invention comprises a filling device in addition to the proportioning device in fluid-conducting connection with the pipe system, wherein the filling device comprises a filling valve and a filling supply for supplying a filling foam agent fluid mixture. The filling supply provides a filling foam agent fluid mixture, whereby the filling foam agent fluid mixture from the filling supply can differ from the foam agent fluid mixture from the proportioning device. Preferably, these two foam agent fluid mixtures are substantially the same. This means that the initial fluid of the two mixtures is similar, although not necessarily from the same source. For example, both initial fluids are water. Furthermore, the foam agent used is preferably also the same, i.e. with the same ingredients, although possibly in different concentrations. It can be advantageous that both foam agent fluid mixtures have different target proportioning rates, i.e. the proportioning rate that is to be generated in the intended manner. Alternatively, it may also be advantageous for identical target proportioning rates to be set.

The filling device is fundamentally different from the proportioning device. The filling device enables the introduction of filling foam agent fluid mixture into the pipe system without the fluid supply, in particular a fluid pump of the fluid supply, and the proportioning device having to be activated. This has the advantage that the disadvantages recognized by the applicant can be avoided in the case of small quantities of liquid to be filled.

Preferably, the filling supply comprises a filling pump which, when the filling foam agent fluid mixture is otherwise supplied without pressure, can operate against a pressure that normally prevails in the pipe system in order to convey the mixture into the pipe system.

In a preferred embodiment, the filling foam agent fluid mixture is provided in the filling supply as a ready-mixed and homogeneous mixture, a so-called premix.

In another preferred embodiment, the filling supply comprises a mixing device with which a filling foam agent fluid mixture can be produced on site from a fluid, preferably the initial fluid, and a foam agent. Preferably, this is a fluid tank into which the initial fluid and the foam agent can be introduced, with a stirring or circulating device, such as a circulating pump.

The filling valve ensures that no foam agent fluid mixture can escape from the pipe system through the filling device. The filling valve can comprise a remote-controlled valve or a manual valve, preferably a ball valve, in order to establish or shut off the fluid connection to the pipe system in a controlled manner. Additionally or alternatively, the filling valve can include a non-return valve to prevent the foam agent fluid mixture from escaping even more reliably.

In a preferred embodiment, the pipe system comprises a shut-off valve, which is connected upstream of the filling device, between the fluid supply and the extinguishing foam outlets, particularly advantageously between the fluid supply and an alarm valve. In a particularly preferred embodiment, the shut-off valve is connected downstream of a pump start pressure switch of a fluid pump, so that when the shut-off valve is shut off, the filling device and the pump start pressure switch are also disconnected. This effectively suppresses the functionality of the fluid supply. An alternative embodiment for suppressing the functionality of the fluid supply is to switch off a fluid pump and/or the fluid pump start control. For this purpose, the power supply to the fluid pump or the signal transmission of a start signal in the fluid pump start control can be interrupted.

In preferred embodiments, the foam extinguishing system comprises at least one extraction device in fluid-conducting connection with the pipe system. The extraction device allows samples of the foam agent fluid mixture present in the pipe system to be extracted. For this purpose, the extraction device comprises an extraction valve for opening and closing the fluid connection between the pipe system and the extraction outlet.

The extraction valve is preferably a manually controllable valve such as a ball valve. Alternatively, the extraction valve can also be remote-controlled.

The extraction outlet is preferably open and comprises a connection point for a sample container or for a hose or tube for introducing the sample into a sample container. Since the samples are usually to be examined at other locations, it is preferable to design the connection between the extraction device and a sample container to be detachable.

In a preferred embodiment, the pipe system comprises several, particularly preferably at least three, extraction devices in fluid-conducting connection with the pipe system, whereby the extraction devices are arranged at different points in the pipe network. This allows a large quantity of the foam agent fluid mixture in the pipe network to be covered by sampling.

In a preferred further embodiment, an extraction valve of an extraction device and the filling valve are realized together in a directional valve, particularly preferably a 3/3 directional valve. A first connection of the directional valve would be fluid-conducting with the extraction outlet of the extraction device, a second connection would be fluid-conducting with the filling supply and a third connection would be fluid-conducting with the pipe system. This means that both functions, filling and sampling, can be performed at one point to save space.

It is particularly preferable for the directional valve to be arranged on a bypass around an alarm valve. This makes it possible to carry out filling as close as possible to the proportioning device without an unlocked alarm valve being forced open by the fluid pressure during filling. At the same time, this positioning of the directional valve also allows samples to be taken as close as possible to the proportioning device.

The method according to the invention for ensuring the functionality of a foam extinguishing system comprises a foam extinguishing system, the foam extinguishing system comprising a fluid supply for providing a pressurized initial fluid, a pipe system in fluid-conducting connection with the fluid supply, a filling device in fluid-conducting connection with the pipe system, comprising a filling valve and a filling supply for supplying filling foam agent fluid mixture, at least one extraction device in fluid-conducting connection with the pipe system, the filling device comprising in each case an extraction valve and an extraction outlet, wherein the pipe system comprises a proportioning device with a foam proportioner and a foam agent reservoir for producing a foam agent fluid mixture by proportioning a foam agent from the foam agent reservoir to the initial fluid for filling the pipe system with foam agent fluid mixture, at least one extinguishing foam outlet for discharging the foam agent fluid mixture in a protected area, and wherein the method comprises the following steps: opening the extraction valve of one of the extraction devices, extracting a sample of the filling foam agent fluid mixture and/or the foam agent fluid mixture at this extraction device, closing the extraction valve of this extraction device after extracting the sample, providing a foam agent fluid mixture in the filling supply, filling the pipe system with the filling foam agent fluid mixture by means of the filling device, after closing the extraction valve.

The foam extinguishing system used and its embodiments have already been described.

The opening of an extraction valve leads to the discharge of a foam agent fluid mixture and enables a sample to be taken by collecting the mixture in a suitable device such as a sample container. Preferably about 5 liters, particularly preferably up to 30 liters are taken. The sample volume is subject to the compromise between accuracy requirements for the sample analysis and cost-effectiveness with regard to used foam agent and disposal costs of the sample taken.

Once the sample has been taken, the extraction valve is closed again to prevent further unwanted discharge.

In a preferred embodiment of the method for ensuring the functionality of a foam extinguishing system, the foam extinguishing system comprises a plurality of extraction devices and the method steps of opening the extraction valves of one of the extraction devices, extracting a sample and closing the extraction valves are performed for each of the plurality of extraction devices. Particularly preferably, these three steps are first carried out completely for a first extraction device, then for a second extraction device, and so on. This makes it possible for the process to be carried out by one person when the extraction device is handled manually.

In a further preferred embodiment of the method for ensuring the functionality of a foam extinguishing system, the functionality of the fluid supply is suppressed as described above.

The method according to the invention for commissioning a foam extinguishing system comprises a foam extinguishing system, wherein the foam extinguishing system comprises a fluid supply for providing a pressurized initial fluid, a pipe system in fluid-conducting connection with the fluid supply, a filling device in fluid-conducting connection with the pipe system, the filling device comprising a filling valve and a filling supply for supplying filling foam agent fluid mixture, wherein the pipe system comprises a proportioning device with a foam proportioner and a foam agent reservoir for producing a foam agent fluid mixture by proportioning a foam agent from the foam agent reservoir to the initial fluid for filling the pipe system with foam agent fluid mixture, at least one extinguishing foam outlet for discharging the foam agent fluid mixture in a protected area, and wherein the method comprises the following steps: providing a filling foam agent fluid mixture by the filling supply, suppressing the functionality of the fluid supply, and filling the pipe system with the filling foam agent fluid mixture by means of the filling device.

In a preferred embodiment of the method for commissioning a foam extinguishing system, the pipe system is filled for a predetermined duration or a predetermined filling volume. The amount required for filling is determined in advance in order to avoid unnecessary consumption of foam agent on the one hand and unnecessary disposal on the other. It is particularly preferable to fill the pipe system until the pipe system is completely filled with the foam agent fluid mixture. This ensures that the pipe system is completely filled with a mixture with the required proportioning rate in order to ensure the best possible extinguishing capacity of the foam extinguishing system.

In a further preferred embodiment of the method for commissioning a foam extinguishing system, the foam extinguishing system comprises at least one extraction device in fluid-conducting connection with the pipe system, and the process step of emptying the pipe system by means of the extraction device during filling. For example, the extraction valve can be opened for the duration of filling, preferably for a predetermined period of time, so that residual liquids and air can be removed from the pipe system. The remaining liquids may be liquids introduced as a replacement, such as antifreeze or corrosion inhibitor, in order to keep the extinguishing system in good condition until it is put into operation. Alternatively, they may be foam agent fluid mixtures that were introduced earlier and are to be removed in order to produce a system with a fresh foam agent fluid mixture with a defined proportioning rate. In one embodiment, emptying during filling is exclusively venting. An alternative extraction device can also be provided for this purpose, which is air-permeable but not foam agent fluid mixture-permeable, so that the risk of accidental discharge of fresh foam agent fluid mixture through this extraction device is reduced.

All disclosed embodiments of the foam extinguishing system are also to be understood as directly and unambiguously disclosed for the described methods, and vice versa. Preferred embodiments of the foam extinguishing system are also preferred embodiments of the method for commissioning and the method for ensuring functionality, and vice versa.

### BRIEF DESCRIPTION OF THE DRAWINGS

The invention is described in more detail below with reference to the attached figures by means of preferred embodiments.

FIG. 1 shows a schematic overview of an embodiment of the foam extinguishing system according to the invention,

FIG. 2 shows an alternative schematic overview of an embodiment of the foam extinguishing system according to the invention.

### DETAILED DESCRIPTION OF THE INVENTION

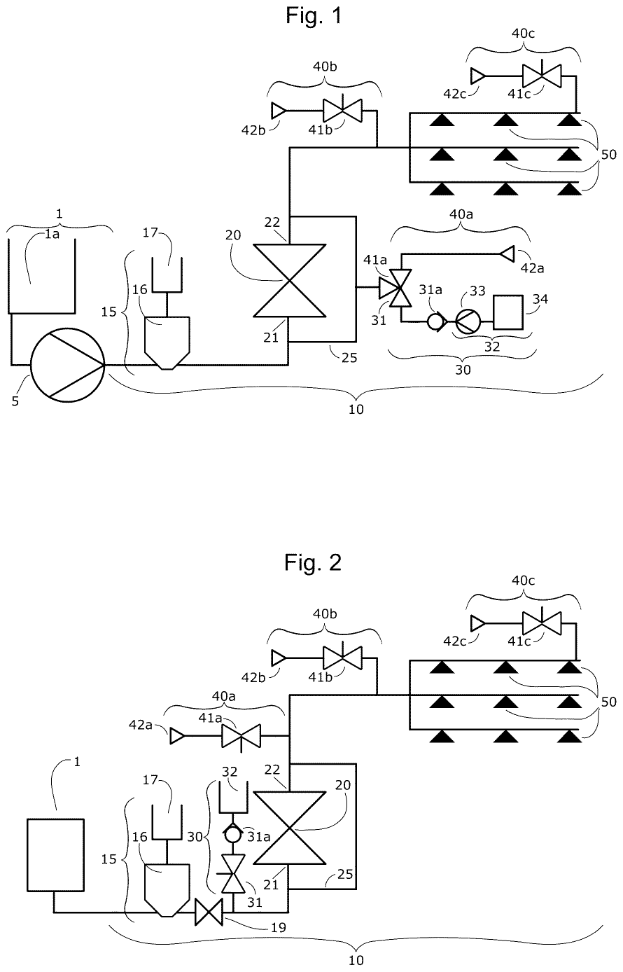

FIG. 1 shows a foam extinguishing system with a fluid supply (1) consisting of a fluid reservoir (1a) and a fluid pump (5). The fluid pump (5) is connected to a pipe system (10) for supplying an initial fluid, which is provided by the fluid reservoir (1a).

The proportioning device (15), which consists of a foam proportioner (16) and a foam agent reservoir (17), is located directly downstream of the fluid pump (5) in the pipe system. The foam agent reservoir (17) provides the foam agent, which the foam proportioner (16) mixes into the initial fluid to produce a foam agent fluid mixture.

An alarm valve (20) with a bypass (25), which connects the alarm valve inlet (21) and alarm valve outlet (22) to each other in a fluid-conducting manner, is connected downstream of the proportioning device (15).

A multi-way valve, more precisely a 3/3-way valve (31, 41a), is connected to this bypass (25), which is connected at its one outlet (31) to the filling device (30), which also has a non-return valve (31a) and a filling supply (32), whereby the filling supply (32) has a filling pump (33) and a mixing device (34). An extraction device (40a) with an extraction outlet (42a) is connected to the other, remaining outlet (41a) of the 3/3-way valve. The 3/3-way valve is configured such that in a first switch position only the fluid connection between the bypass (25) and the filling device (30) is established, in a second switch position only the fluid connection between the bypass (25) and the extraction device (40a) is established, and in a third switch position the outlet to the bypass remains closed.

At the alarm valve outlet (22), the pipe system (10) leads to a group of extinguishing foam outlets (50), which are configured to discharge the foam agent fluid mixture.

Between the alarm valve outlet (22) and the group of extinguishing foam outlets (50), a second extraction device (40b) with an extraction outlet (42b) downstream of an extraction valve (41b) is connected in a fluid-conducting manner.

A third extraction device (40c) with an extraction outlet (42c) downstream of an extraction valve (41c) is connected at a remote point in the pipe network (10) in the immediate vicinity of the extinguishing foam outlets (50).

FIG. 2 shows a foam extinguishing system similar to FIG. 1. The differences between the foam extinguishing system in FIG. 2 and FIG. 1 are described below.

In contrast to FIG. 1, the foam extinguishing system of FIG. 2 has a different preferred fluid supply (1), whereby this fluid supply (1) also provides pressurized initial fluid without a local fluid pump. For example, this is a pressurized, municipal water connection.

FIG. 2 also shows an additional shut-off valve (19) between the alarm valve inlet (21) and the proportioning device (15), and the filling device (30), which is not connected to the bypass (25) of the alarm valve but to the pipe network (10) between the shut-off valve (19) and the alarm valve inlet (21) in a fluid-conducting manner.

The filling device (30) also has a non-return valve (31a) and a filling supply (32), which does not, however, consist of a mixing device and a filling pump. Instead, the filling supply (32) can consist of a pressure-building membrane tank, which is filled with premix and therefore still requires a mixing device and a filling pump. The filling device (30) here has a filling valve (31) in the form of a two-way valve, which is not constructively combined with the extraction valve of the first extraction device.

FIG. 2 also shows the first extraction device (40a) with an extraction outlet (42a) downstream of an extraction valve (41a), which, like the filling valve (31), is designed as a two-way valve.

### LIST OF REFERENCE NUMERALS

Fluid supply 1

Fluid reservoir 1a

Fluid pump 5

Pipe system 10

Proportioning device 15

Foam proportioner 16

Foam agent reservoir 17

Shut-off valve 19

Alarm valve 20

Alarm valve inlet 21

Alarm valve outlet 22

Alarm valve bypass 25

Filling device 30

Filling valve 31,31a

Filling supply 32

Filling pump 33

Mixing device 34

Extraction device 40a,b,c

Extraction valve 41a,b,c

Extraction outlet 42a,b,c

Extinguishing foam outlets 50

1. A method for commissioning a foam extinguishing system, the foam extinguishing system comprising:
a fluid supply for providing a pressurized initial fluid,
a pipe system in fluid-conducting connection with the fluid supply,
a filling device in fluid-conducting connection with the pipe system, the filling device comprising a filling valve (31, 31a) and a filling supply for supplying a filling foam agent fluid mixture,
wherein the pipe system comprises
a proportioning device with a foam proportioner and a foam agent reservoir for producing a foam agent fluid mixture by proportioning a foam agent from the foam agent reservoir into the initial fluid for filling the pipe system with the foam agent fluid mixture,
at least one extinguishing foam outlet for discharging the foam agent fluid mixture in a protected area,
and wherein the method comprises the following steps:
Providing the filling foam agent fluid mixture by the filling supply,
Suppressing the functionality of the fluid supply, and
Filling the pipe system with the filling foam agent fluid mixture by means of the filling device.

2. The method according to claim 1, wherein filling the pipe system is carried out for a predetermined duration or a predetermined filling volume.

3. The method according to claim 2, wherein filling the pipe system is carried out until the pipe system is completely filled with the foam agent fluid mixture.

4. The method according to claim 1, wherein
the fluid supply comprises a fluid pump with a fluid pump start control in fluid-conducting connection with the pipe system for conveying the initial fluid in the pipe system, and
suppressing the functionality of the fluid supply comprises switching off the fluid pump and/or the fluid pump start control.

5. The method according to claim 1, wherein
suppressing the functionality of the fluid supply comprises shutting off a section of the pipe system, the section being downstream of a fluid pump and/or the proportioning device and/or a fluid pump start control, and
the shutting off is performed by a shut-off valve and/or an alarm valve.

6. The method according to claim 1, wherein
the foam extinguishing system comprises at least one extraction device in fluid-conducting connection with the pipe system, each comprising an extraction valve and an extraction outlet, and
the method further comprises
Venting the pipe system by the extraction device during filling.

7. A method for ensuring the functionality of a foam extinguishing system,
wherein the foam extinguishing system comprises:
a fluid supply for providing a pressurized initial fluid,
a pipe system in fluid-conducting connection with the fluid supply,
a filling device in fluid-conducting connection with the pipe system, comprising a filling valve and a filling supply for supplying a filling foam agent fluid mixture, and
at least one extraction device in fluid-conducting connection with the pipe system, the filling device comprising each an extraction valve and an extraction outlet,
wherein the pipe system comprises:
a proportioning device with a foam proportioner and a foam agent reservoir for producing a foam agent fluid mixture by proportioning a foam agent from the foam agent reservoir into the initial fluid for filling the pipe system with the foam agent fluid mixture, and
at least one extinguishing foam outlet for discharging the foam agent fluid mixture in a protected area,
wherein the method comprises:
Opening the extraction valve of one of the extraction devices,
Extracting a sample of the foam agent fluid mixture and/or the filling foam agent fluid mixture at this extraction device,
Closing the extraction valve of this extraction device after extracting the sample,
Providing the filling foam agent fluid mixture in the filling supply,
Filling the pipe system with the filling foam agent fluid mixture by the filling device after closing the extraction valve.

8. The method for ensuring the functionality of a foam extinguishing system according to claim 7, wherein the method further comprises
Suppressing the functionality of the fluid supply.

9. The method for ensuring the functionality of a foam extinguishing system according to claim 7, wherein the foam extinguishing system comprises at least three extraction devices, each with an extraction valve,
and wherein the method comprises
Opening the extraction valves of one of the extraction devices,
Extracting a sample, and
Closing the extraction valves
being carried out for each of the at least three extraction devices.

10. The method according to claim 7, wherein
the filling supply comprises a filling pump, and
filling the pipe system with the filling foam agent fluid mixture is carried out by the filling pump.

11. The method according to claim 10, wherein
the filling supply comprises a mixing device, and
the method further comprises:
Generating the filling foam agent fluid mixture by mixing a foam agent and a fluid with the mixing device.

12. A foam extinguishing system, comprising
a fluid supply for providing a pressurized initial fluid,
a pipe system in fluid-conducting connection with the fluid supply,
wherein the pipe system comprises
a proportioning device with a foam proportioner and a foam agent reservoir for producing a foam agent fluid mixture by proportioning a foam agent from the foam agent reservoir into the initial fluid for filling the pipe system with the foam agent fluid mixture,
at least one extinguishing foam outlet for discharging the foam agent fluid mixture in a protected area,
wherein
the foam extinguishing system further comprises a filling device in fluid-conducting connection with the pipe system, the filling device comprising a filling valve and a filling supply for supplying a filling foam agent fluid mixture.

13. The foam extinguishing system according to claim 12, wherein the foam extinguishing system comprises at least one extraction device, each with an extraction valve and an extraction outlet.

14. The foam extinguishing system according to claim 12, wherein the fluid supply comprises a fluid pump with a fluid pump start control in fluid-conducting connection with the pipe system for conveying the initial fluid in the pipe system.

15. The foam extinguishing system according to claim 13, wherein an extraction valve of one of the extraction devices is present in combination with the filling valve together in the form of a directional valve with at least three connections, a first connection being connected in a fluid-conducting manner to the extraction outlet of these extraction devices, a second connection being connected in a fluid-conducting manner to the filling supply and a third connection being connected in a fluid-conducting manner to the pipe system.

16. The foam extinguishing system according to claim 15, wherein the pipe system comprises an alarm valve and a bypass around the alarm valve, and the directional valve is connected to the bypass at the third connection in a fluid-conducting manner.

17. The method of claim 7, wherein the foam agent fluid mixture and the filling foam agent fluid mixture comprise different ingredients.

18. The method of claim 7, wherein the foam agent fluid mixture and the filling foam agent fluid mixture comprise similar ingredients.

19. The method of claim 7, wherein the foam agent fluid mixture comprises a ready-mixed and homogeneous mixture.

20. The method of claim 7, wherein the foam agent fluid mixture and the filling foam agent fluid mixture comprise different concentrations.
